(19) United States
(12) Patent Application Publication
(10) Pub. No.: US 2025/0277663 A1
(43) Pub. Date: Sep. 4, 2025

(54) Hybrid Image Processing System for Celestial Navigation

(71) Applicant: The Charles Stark Draper Laboratory, Inc., Cambridge, MA (US)

(72) Inventors: Roberto Acosta, Cambridge, MA (US); Lorena Iannicelli, Cambridge, MA (US); Jorge Rubenstein, Cambridge, MA (US); Alexander Moody, Cambridge, MA (US); Sofia Conte, Cambridge, MA (US)

(21) Appl. No.: 19/066,372

(22) Filed: Feb. 28, 2025

Related U.S. Application Data
(60) Provisional application No. 63/559,711, filed on Feb. 29, 2024.

(51) Int. Cl. G01C 21/02; B64G 3/00; G06T 5/30; G06T 5/70; G06T 7/246; G06T 7/73; G06V 10/25

(52) U.S. Cl. CPC G01C 21/025; B64G 3/00; G06T 5/30; G06T 5/70; G06T 7/246; G06T 7/73; G06V 10/25; G06T 2207/10016; G06T 2207/10032

(57) ABSTRACT

A method for localization of a platform includes receiving, at a region of interest processor, region of interest data representing less than an entire focal plane array of an image sensor and comprising a number of regions of the focal plane array of the image sensor, where the number of regions includes a first region containing a first stellar object, for each time of a number of successive times, processing the region of interest data, including extracting image data from the focal plane array of the image sensor for the number of regions, processing the image data for the first region to update a track of movement of the first stellar object through said first region. For at least a first time of the number of successive times, the method includes determining that the first stellar object will move out of the first region and updating a location in the imaging sensor of the first region at the first time according to the track of the first stellar object, for use in processing the region of interest data at subsequent times.

### CROSS-REFERENCES TO RELATED APPLICATIONS

This application claims the benefit of U.S. Provisional Application No. 63/559,711 filed Feb. 29, 2024, the entire contents of which are incorporated herein by reference.

### BACKGROUND OF THE INVENTION

Aspects of the disclosure generally relate to a hybrid system for processing images for use in a celestial navigation system deployed on a moving platform.

Celestial navigation techniques have been in use since ancient times, with stars originally providing direction information to voyagers, e.g., Polaris. Until the 1950s, the elevation angles would be measured against a vertical reference provided by the horizon at sea. Subsequent mechanizations of the process rely on inertial instruments to maintain knowledge of the local vertical when the horizon is obscured or when the measurement is done from a moving platform such as an aircraft. However, the inherent drift of inertial sensors limits the accuracy of the vertical measurement and ultimately system performance.

It has long been known that it is possible to derive one's position by observing an orbiting satellite against a star-field background. Angles between an apparent position of the satellite and (assumed known) stars contain information on the location of the observer. This method requires the position of the satellite be known accurately. Given that satellite orbits can be predicted using well-known physical equations, e.g., Kepler's and Newton's laws, this technique can provide a practical method of navigation.

A technique, dubbed “SkyMark,” was developed at The Charles Stark Draper Laboratory, Inc. (“Draper”) four decades ago and has been closely investigated since then for use in a variety of applications, including autonomous spacecraft navigation. FIG. 1 schematically illustrates the principles of operation of SkyMark. Draper has been a pioneer in SkyMark with published works on SkyMark that include a Draper Fellow Master's MIT thesis (Willhite, W. B., An Analysis of ICBM Navigation Using Optical Observations of Existing Space Objects, CSDL-T-1484, Masters Thesis, Massachusetts Institute of Technology, June 2004, the entire contents of which are hereby incorporated by reference), and in Shearer, J., et al., “Skymark—A Technique for Enhancing Precision Missile Navigation,” AIAA Missile Sciences Conf., (November 2004), which is also incorporated herein by reference.

As depicted in FIG. 1, a star tracker (not shown in FIG. 1) associated with a vehicle 100 is used to measure a direction (indicated by ray 102) toward a celestial object 104 (in the case shown, a fixed star) and a direction R₁ toward a skymark 106 at one or more instants of time, noting that the terms “star” and “skymark” are defined below. The angle between the two directions 102 and R₁ is designated θ. A star tracker may use information in a star catalog to locate itself and its associated vehicle in space.

The concept of using satellite sightings together with inertial guidance for navigation purposes was discussed by Brown et al. in “Long Duration Strapdown Stellar-Inertial Navigation using Satellite Tracking,” Position Location and Navigation Symposium, 1992. Record. 500 Years after Columbus—Navigation Challenges of Tomorrow. IEEE PLANS'92, IEEE, pp. 194-201 (1992), which is incorporated herein by reference.

### SUMMARY OF THE INVENTION

In a general aspect, a method for localization of a platform includes receiving, at a region of interest processor, region of interest data representing less than an entire focal plane array of an image sensor and comprising a number of regions of the focal plane array of the image sensor, where the number of regions includes a first region containing a first stellar object, for each time of a number of successive times, processing the region of interest data, including extracting image data from the focal plane array of the image sensor for the number of regions, processing the image data for the first region to update a track of movement of the first stellar object through said first region. For at least a first time or a number of successive times, the method includes determining that the first stellar object will move out of the first region and updating a location in the imaging sensor of the first region at the first time according to the track of the first stellar object, for use in processing the region of interest data at subsequent times.

Aspects may have one or more of the following features.

The method may include extracting full-frame image data from the entire focal plane array of the image sensor, processing the full-frame image data to identify a number of candidate stellar objects in the full-frame image data, and providing the number of candidate stellar objects to flight software. The method may include processing the number of candidate stellar objects in the flight software to determine the region of interest data. The method may include processing the full-frame image data is performed in firmware.

The method may include processing the image data for the first region to update the track of movement of the first stellar object, determining that the stellar object will move out of the first region, and updating the location in the imaging sensor of the first region at the first time is performed in firmware. The method may include processing the image data for the first region to update the track of movement of the first stellar object, determining that the stellar object will move out of the first region, and updating the location in the imaging sensor of the first region at the first time is performed in software. Updating the track of movement for the first stellar object may include compensating for a movement of one or both of the platform and the first stellar object. Updating the track of movement for the first stellar object may include using a tracking filter.

The method may include, for each region of the region of interest data, processing a number of successive images extracted at the number of successive times to identify a centroid of the stellar object in the region. Identifying the centroid of the stellar object in the region may include determining a background image for the region and subtracting the background image from the number of successive images. Identifying the centroid of the stellar object in the region may include compensating for a motion of one or both of the stellar object in the region and the platform in the number of successive images to generate a number of motion-compensated successive images. Identifying the centroid of the stellar object in the region may include stacking the number of motion-compensated successive images to generate a stacked image. Identifying the centroid of the stellar object in the region may include applying a two-dimensional filter to the stacked image to generate a filtered image. Identifying the centroid of the stellar object in the region may include applying a threshold to the filtered image to generate a thresholded image. Identifying the centroid of the stellar object in the region may include identifying pixels associated with the stellar object in the region using a connected component analysis. Identifying the centroid of the stellar object in the region may include performing erosion and/or dilation on the identified pixels. Identifying the centroid of the stellar object in the region may include calculating a center of mass of the identified pixels. The centroid may be associated with a timestamp.

In another general aspect, a system for localization of a platform includes an input for receiving, at a region of interest processor, region of interest data representing less than an entire focal plane array of an image sensor and comprising a number of regions of the focal plane array of the image sensor, where the number of regions includes a first region containing a first stellar object and one or more processing modules configured to, for each time of a number of successive times, process the region of interest data. The processing includes extracting image data from the focal plane array of the image sensor for the number of regions, processing the image data for the first region to update a track of movement of the first stellar object through said first region. For at least a first time of the number of successive times, the processing includes determining that the first stellar object will move out of the first region and updating a location in the imaging sensor of the first region at the first time according to the track of the first stellar object, for use in processing the region of interest data at subsequent times.

In another general aspect, data stored on a non-transitory medium includes configuration instructions for configuring a circuit, the circuit having an input for receiving, at a region of interest processor, region of interest data representing less than an entire focal plane array of an image sensor and comprising a number of regions of the focal plane array of the image sensor, where the number of regions includes a first region containing a first stellar object and one or more processing modules configured to, for each time of a number of successive times, process the region of interest. The processing includes extracting image data from the focal plane array of the image sensor for the number of regions, processing the image data for the first region to update a track of movement of the first stellar object through said first region, and for at least a first time of the number of successive times, determining that the first stellar object will move out of the first region and updating a location in the imaging sensor of the first region at the first time according to the track of the first stellar object, for use in processing the region of interest data at subsequent times.

Using satellite sightings for positioning oneself requires not only obtaining image and other information about the satellites, but it also requires performing a great deal of image processing. Due to the enormous amount of image data and the complexity of using celestial navigation on moving platforms, methods are needed to bifurcate image processing between firmware and a GPU as well as narrow down the scope of processing to regions of interest.

It is often challenging to navigate using celestial bodies, space objects, or satellites from a moving platform. Movement of the platform (or vehicle) causes variations in the received images which further complicates the navigation methods. When the vehicle or platform moves through a space at a high speed, the image variations are even more significant. There is a need to process the pixel data received at a sensor quickly so as to minimize the effects of image variations on celestial navigation.

Aspects described herein relate to a system for offloading portions of image processing to a field programmable gate array (FPGA). Offloading a portion of the image processing permits the processing of multiple frames at a time, allows for scalability, and ultimately creates a low-power system with low latency. The time required for the full processing of image data by a GPU introduces a tremendous amount of latency into the system which can render the celestial imaging system incompatible with navigation applications used on high-speed objects (i.e., such as objects moving at Mach 5 or greater).

Celestial navigation, which is desirable in GPS-denied environments, relies on high-fidelity images to determine position. To enhance camera sensitivity sighting during certain conditions, multiple images are captured with a short integration time and subsequently stacked to avoid saturation while still getting a detailed image. In this case the motion of the sighted object and the vehicle's motion both cause blur in the stacked image, degrading the accuracy of the centroid.

The firmware architecture and implementation of motion compensation in the system (i.e., hybrid image processor) described herein compensates for the motion of both the sighted object and the vehicle's motion. The algorithm uses satellite velocities (known a priori) and real-time delta thetas from a local IMU to calculate a translational x/y shift. The x/y shift describes the motion, in terms of image pixels that the stellar object has moved in the current image relative to the first image of the stack. Applying this shift allows for the stellar object in each image to be stacked on top of each other, thereby improving the relative signal-to-noise ratio. The firmware architecture defines a time-multiplexed design that is scalable to N number of regions of interest.

The described star tracker system implements a novel and unique solution for tracking resident stellar objects (RSOs) within the field of view of a sensor. The design implemented advantageously results in a significant decrease in power (86% power reduction from a software-only solution), a decrease in the time it takes to calculate the location of the RSO (sub milliseconds) and a significant reduction in the data to be processed by a central CPU/GPU (>99% data reduction). This architecture allows for scaling of multiple sighting opportunities (by increasing the number of sensors or the number of areas to be tracked within a sensor) without having to significantly increase the number of CPU/GPU resources. The design and architecture allow for celestial navigation to be performed in a compact, low power and low-size package.

Aspects provide low power, low latency image processing that reduces the power consumed by primarily software-based image processing systems and enables celestial navigation in size-weigh-and-power (SWAP) constrained environments. In some instances, this power reduction is benchmarked at 86% power reduction. Aspects reduce the amount of data needed to be processed by a command computer by at least 95%, permitting scalability of the sensor without having to scale compute resources. Additionally, the image data is processed at the node which reduces the need to route sensor information over high-speed networks to an avionics computer, and the overall design is scalable by an instantiation of multiple pipelines and is scalable in the time domain allowing for region of interest processing to be done with a reduced number of logic elements. Aspects reduce the amount of time needed to obtain a location of a stellar object which improves the navigational accuracy of the navigation system within which it is deployed.

In some aspects, the architecture includes some or all of the following hardware circuits: sensor interface, cropping module, auto-tracking module, background subtract module, motion compensation module, frame displacement module, frame stacking module, 2D filtering module, threshold module, dilation module, erosion module, connected component analysis module, centroiding module, full frame object selection with clustering, intensity-based full frame object selection, processor interface module, data collection ports, external memory interface and external inertial measurement unit (IMU) module.

The architecture processes data via two main modes: full frame and Region of Interest (ROI). In full frame mode, the design is capable of receiving the full stream of pixels at the full sensor rate and provides the central CPU/GPU with a reduced set of data points that can be used to determine pointing initialization. In full frame mode, the architecture utilizes the distributed bright object detector block to determine the objects of interest. This block provides a software-programmable cluster area that defines the separation distance required between bright objects to be considered unique detections. The locations of the bright objects are sent to the software; this operation reduces the CPU/GPU overhead by having the Firmware provide a succinct report of the brightest pixels in the frame. The data reduction as seen by the CPU/GPU when the firmware calculated the centroid is on the order of 99.11% In full frame mode, the firmware will collect a large set of data based on intensity from the focal plane and provide that information in packet form to the CPU/GPU. The operation of selecting RSO by intensity when done in the firmware reduces the data seen by the CPU/GPU by 99.96% allowing the CPU/GPU to only concentrate on the selected data points to perform pointing initialization.

In region of interest (ROI) mode, the FPGA can select a number of regions of interest (ROIs) from the focal plane and perform object detection and tracking, providing continuous updates of the locations of various objects to the CPU/GPU. The CPU/GPU can use the location information to determine the position of the platform. Object detection in ROI mode is done by a series of highly optimized hardware functions that consume pixels at a rate from the focal plane as they are read out, minimizing the latency it takes from a traditional method of reading/writing complete frames into memory. The hardware functions in ROI consist of a cropping module (used to select the area of the focal plane to be examined), a background subtract module (used to remove hot pixels/errors from the focal plane), a motion compensation module that calculates the pixel shift of the image to account for platform motion and object motion, a frame displacement module that shifts the image by a programmable number of pixels, a stacking module to improve object intensity versus frame noise, a linear spatial filter that performs neighborhood processing and spatial filtering with programmable filter coefficients, a threshold module that utilizes frame statistics to determine which pixels should be used as part of the detection, two morphological transforms dilation (used to grow or thicken the objects in an image) and erosion (used to shrink or thin the objects in an image), a connected component analysis module (used to group and identify individual objects within a frame) and a centroiding module (used to determine the center of mass of each object within a frame). The computations are done in a pipelined manner with minimal overhead, resulting in an architecture that can tolerate high frame rates while still maintaining low power. The data to be handled by the CPU/GPU in the ROI case is reduced by 99%, significantly off-loading the CPU/GPU processing needs as well.

Firmware-based auto-tracking of moving RSOs advantageously reduces overhead in communications between the CPU and FPGA and can scale the number of tracked RSOs with minimal impact to the software processing load. Using firmware to determine the next ROI position advantageously reduces the required number of CPU operations. This frees up compute resources for other tasks. Operations will have >90% time efficiency in tracking objects compared to conventional methods.

Aspects advantageously have a deterministic number of clock cycles between ROI location updates (rather than the non-deterministic nature of software processing).

Aspects dynamically crop images to the area of interest, advantageously providing a better opportunity to continuously sight RSOs without increasing the size of the image to be processed. Aspects are advantageously lower power than software-based RSO tracking solutions. Dynamic cropping advantageously allows for minimization of the FPGA resources needed for the ROI pipeline, while optimizing the position of the object within the ROI. This approach can be applied to any sensor and eliminates sensor-based ROI size restrictions.

Other advantages of the system include a fixed point implementation of motion compensation in firmware that optimizes bit growth across many arithmetic operations, and a time multiplexed design that saves hardware resources while allowing for motion compensation to be applied on multiple regions of interest (ROI). The synchronized design coordinates between asynchronous image and IMU data and has the ability to compensate for motion of independent Regions of Interest with respect to platform motion and stellar object motion. The system can further apply motion compensation parameters to different Regions of Interest over time, effectively treating different ROIs as one continuous observation. The region of interest location can be controlled to address shifts in the calculated platform or object motion when a stellar object moves beyond a currently selected field of view. The tracker can also control the stacking length of other modules that implement stacking for image enhancement, compensate motion for a runtime programmable number of frames, begin a new compensation calculation when programmable number of frames is reached, and automatically reset its calculations when commanded to look for a new Region of interest, independently of the number of frames processed. The tracker can also account for lens distortion using programmable bicubic coefficients, account for both image rotation and translational shifts, and minimize error due to timing differences in the IMU data with respect to the frame using extrapolation.

Aspects advantageously compensate for fixed pattern noise, using a column-level correction algorithm that reduces fixed pattern noise with minimal memory and power utilization. Correcting for fixed pattern noise advantageously reduces as noise in the image data that could cause false detections of objects and centroids.

Other features and advantages of the invention are apparent from the following description, and from the claims.

### BRIEF DESCRIPTION OF THE DRAWINGS

FIG. 1 is a schematic diagram illustrating the principles of operation of SkyMark navigation.

FIG. 2 is a schematic block diagram of a navigation system, according to an embodiment of the present invention.

FIG. 3 is a full-frame processor.

FIG. 4 is a full-frame of image data with centroids identified.

FIG. 5 is a region of interest processor.

FIG. 6 shows an image cropping technique.

FIG. 7 is a motion compensation module.

FIG. 8 is a result of connected component analysis.

FIG. 9 illustrates a centroid calculation.

FIG. 10 illustrates the auto-tracking of a resident stellar object over multiple regions of interest.

FIG. 11 is an auto-tracking boundary for a star.

FIG. 12 is an auto-tracking boundary for a satellite.

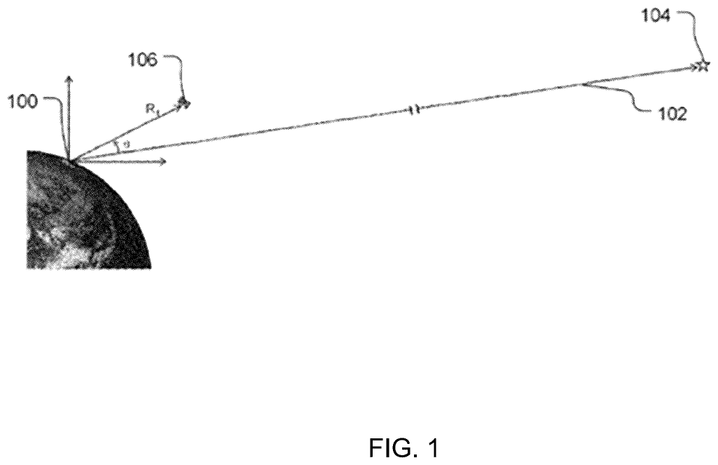

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

### 1 Definitions

As the term is used herein and in any appended claims, the term “skymark” shall refer to any object that meets all three of the following criteria. First, it is in a known and predictable location, which is tantamount to knowledge, by an observer, of an ephemeris of sufficient accuracy for purposes of the observer. Second, it appears to the observer with sufficient brightness as to be readily detectable and trackable. Lastly, it is sufficiently close to the observer as to exhibit parallax over a period of observation by the observer during which the observer is in motion.

A star is so far away that it does not satisfy the last of the forgoing criteria and, while it may serve as a direction reference, a star cannot provide a location reference. A skymark in orbit with a known ephemeris may be used for determining a location based on sighting of the object. Multiple sightings on skymarks are required for the determination of multi-dimensional location in space. Although conventional star trackers typically use navigational stars, other light-emitting or light-reflecting space objects can be used for navigation. For example, most artificial satellites have predictable orbits or other trajectories and can, therefore, be used instead of, or in addition to, stars for navigation.

The term “inertial frame” shall denote a fiducial coordinate frame of reference in which a body at rest remains at rest unless acted upon by a force. When a body is said to be in motion in an inertial frame, it shall be understood that, within the scope of the present invention, motion of the body may be specified within any inertial frame.

The term “navigation state vector,” as the term is used herein and in any appended claims, shall refer to the position, velocity and orientation of a specified platform relative to a specified frame of reference.

“State variables” are variables in a vector space in which a recursive filter operates. State variables may include components of the navigation state vector, and measures of errors in one or more of the components, as well as variables such as the directions to celestial objects within the field of view of a camera, etc.

The term “platform” may be used herein interchangeably with the term “vehicle”.

“Navigation” is a defined term that refers exclusively to a process for ascertaining at least one of the position, velocity and orientation of a specified platform relative to a specified frame of reference.

The term “attitude” refers to the orientation of a platform relative to an inertial frame. The attitude need not be absolute and may be expressed differentially, relative to a fiducial attitude.

The term “star,” as used herein and in any appended claims, shall refer to a point source, i.e., a source of light that is not amenable to spatial resolution by a given optical system, and that is fixed relative to an inertial frame. “Light” is used in a general sense to refer to electromagnetic radiation, whereas “optical” is used in a correspondingly broad sense, unless the context requires otherwise. Thus, for example, “optical” may encompass sensing or processing of visible, infrared, and/or ultraviolet light.

A “satellite” is defined to be a body, natural or artificial, that is gravitationally bound to another body of greater mass.

Insofar as the ephemeris of a satellite is known, and in cases where a satellite meets the other two skymark criteria defined above, a satellite shall constitute a skymark.

Since a star is too distant for any parallax to be useful in a navigational context, a star is distinct from a skymark, as those terms are used herein.

An object shall be referred to as “celestial” with respect to a specified platform that is in motion relative to the surface of a specified body (such as the Earth or other planets), if and only if, the object is substantially further from the center of mass of the specified body than its surface. Thus, on the Earth, a celestial body is any object seen from the surface of the Earth by looking above the horizon. A celestial body need not be a natural object.

The term “recursive estimation filter,” as used herein and in any appended claims, shall denote any recursive estimation algorithm in which estimates of one or more random variables (constituting a state vector in the aggregate), and an uncertainty associated with each random variable, are iteratively updated upon each of a temporal sequence of successive measurements. The general tenets of recursive estimation methods, and the terms used in connection therewith, may be found in Bar-Shalom et al., Estimation with Applications to Tracking and Navigation: Theory Algorithms and Software (Wiley, 2001) (hereinafter, “Bar-Shalom 2001), which is incorporated herein by reference. Another useful reference is Williams, Coupling between Nonlinear Estimation and Dynamic Sensor Tasking Applied to Satellite Tracking, Penn. State U. Ph.D. Dissertation (2012), which is incorporated herein by reference.

The term “instant,” as the term is used herein and in any appended claims, shall refer to a finite duration of time during which one or more parameters are measured. Such measurements may be ascribed to a point in time for computational convenience, without loss of generality.

The term “Kalman filter,” as used herein and in any appended claims, shall be used in a broad sense, encompassing extended Kalman filters as well, shall denote a recursive estimation filter where a state vector xₖ at time k is assumed only to be a general (and not necessarily linear) function ƒ(xₖ₋₁, uₖ) of the state vector xₖ₋₁ at the immediately preceding discretely sampled time k−1 and a control vector uₖ, modulo an additive noise term that is assumed to be drawn from a multivariate normal distribution. As the term is used herein, the system dynamics and observation models are not necessarily limited, as required by a narrower usage of the term “Kalman filter.”

The term “unscented Kalman filter” shall refer to a method for applying Kalman filtering to nonlinear systems without linearizing nonlinearities but by means of an “unscented transform” for calculating the statistics of a random variable undergoing a nonlinear transformation, as taught by Julier et al., “A New Extension of the Kalman Filter to Nonlinear Systems,” AeroSense'97. International Society for Optics and Photonics, pp. 182-93, (1997) (“Julier 1997”), which is incorporated herein by reference. As used herein, the term “unscented transform” shall refer to any deterministic selection of points for establishing the transform of the state error covariance matrix.

The term “tightly coupling” shall refer to the integration of aiding measurements directly into a unitary recursive estimation filter, whereas “loosely coupling” shall refer to processing of the aiding measurements in a separate recursive estimation filter, and their post-filtered incorporation into the recursive estimation filter applied to a primary random state vector. Thus, for example, measurements derived from an inertial navigation systems (INS) may either be tightly coupled, or loosely coupled, to global positioning satellite (GPS) data, as taught, for example, by Kjorsvik, et al., “Tightly coupled precise point positioning and inertial navigation systems,” International calibration and orientation workshop EuroCOW, (2010), which is incorporated herein by reference.

As used herein and in any appended claims, the term “Global Nearest Neighbor” (GNN) shall refer to any method of data association for associating measurements with identified targets in which all possible measurement-to-track pairings are considered whereupon the most likely assignment hypothesis is chosen irrevocably. GNN methods are used in radar, infrared or sonar tracking modalities, and are described by Blackman, “Multiple hypothesis tracking for multiple target tracking” Aerospace and Electronic Systems Magazine, IEEE, vol. 19, pp. 5-18 (2004) (hereinafter, “Blackman 2004”), which publication is incorporated by reference herein.

In certain embodiments that fall within the scope of the present invention, other data association methods may be used advantageously to associate measurements with identified targets. Various data association methods, including GNN and multi-hypothesis tracking (MHT) are described by Blackman et al., Design and Analysis of Modern Tracking Systems, Artech House (2009) (hereinafter, “Blackman & Popoli 2009”), incorporated herein by reference.

The term “multi-hypothesis tracking” (or “Reid's algorithm”), as used herein and in any appended claims, shall refer to any tracking algorithm in which multiple solution branches are retained and a set (possibly including either a proper subset or the entire set) of solution branches is updated during each discrete sensor dwell, and solutions may subsequently be pruned applying any of a variety of pruning criteria, as described below.

More particularly, the term “multi-hypothesis tracking” encompasses the use of multiple navigation hypotheses, wherein multiple hypotheses of bright spots to star/satellite assignments are retained in case one or more of them is wrong.

An inertial navigation system (INS) is any sensor or combination of sensors used for measuring attitude (differential or absolute) of a platform relative to an inertial frame. Inertial navigation systems may employ accelerometers, where the term “accelerometers” is used in the most general sense and encompasses gyroscopes for the measurement of rotation.

A “subset,” as used herein and in any appended claims, shall refer either to a non-empty proper subset of a specified set, or to the entirety of the specified set.

The term “image” shall refer to any multidimensional representation, whether intangible or otherwise perceptible form, or otherwise, whereby a value of some characteristic (typically intensity) is associated with each of a number of locations corresponding to dimensional coordinates of an object with respect to a sensor array, though not necessarily mapped one-to-one thereonto. Thus, for example, the graphic display of the spatial distribution of some field, either scalar or vectorial, such as intensity, constitutes an image. So, also, does an array of numbers, such as an N-dimensional holographic dataset, in a computer memory or holographic medium. Similarly, “imaging” refers to the rendering of a stated physical characteristic in terms of one or more images.

A “frame” shall constitute an image associated with a specified instant or duration of time. “Frame stacking,” as the term is used herein and in any appended claims, shall refer to any algorithm used to co-process multiple images obtained at non-identical times. Co-processing may include averaging, in the broadest sense, or other manipulation of registered images.

In accordance with embodiments of the present invention, improved methods and apparatus are disclosed for collecting data, processing the data and integrating such methods and apparatus into complete navigational solutions, in relation to acquiring navigational position fixes by observing stars and natural and man-made satellites.

Most artificial satellites, spacecraft and other propelled devices such as aircraft, ship and ground vehicles (collectively referred to herein as vehicles) require information about their locations and/or attitudes to accomplish their missions. This information may be obtained from one or more sources, such as the global positioning system (GPS), ground-based radar tracking stations and/or an on-board star tracker.

A star tracker is an optical device that measures bearing(s) to one or more celestial objects, as viewed from a vehicle. A star tracker typically includes a star catalog that lists bright navigational stars and information about their locations in the sky, sufficient to calculate an attitude of a vehicle in space, given bearings to several stars. A conventional star tracker includes a lens that projects an image of a star onto a photocell, or that projects an image of one or more stars onto a light-sensitive sensor array (digital camera).

The term “tracker” may be used herein more generally than the term “star tracker,” and may encompass devices that follow and process features within a field of view from frame to frame.

One type of star tracker is “strapped-down,” meaning its view angle, relative to its vehicle, is fixed. Another type of star tracker can be aimed mechanically, such as in a direction in which a navigational star is expected to be seen. Using data from the photocell or sensor array, the star catalog and information about the star tracker's view angle, relative to the vehicle, the star tracker calculates a position of the vehicle in space.

Strapped-down star trackers are mechanically simpler than mechanically aimable star trackers. However, the fixed view angle of a strapped-down star tracker limits the number of navigational stars that may be used. Mechanically aimable start trackers can use a larger number of navigational stars. However, aiming a prior art star tracker, relative to its vehicle, with the required precision poses substantial problems. In either case, preventing stray light, such as from the sun or reflected from the moon, reaching the photocell or sensor array is challenging, particularly when a navigational star of interest is apparently close to one of these very bright objects.

As has been noted, a star tracker measures bearing(s) to one or more navigational stars and/or other celestial objects and may use information in a star catalog to locate itself and its associated vehicle, in space. However, instead of imaging a navigational star through clear space, a star tracker may image the navigational star (or other celestial body) through an atmospheric limb of the earth. A “limb” is an apparent visual edge of a celestial body as viewed from space. An “atmospheric limb” is a thin layer near the horizon, as viewed from space, corresponding to an atmosphere. As viewed from space, a star passing behind earth's upper atmosphere appears to shift upward, i.e., away from the center of the earth, from its true position due to refraction of the star's light as the light passes through the atmosphere. The amount of refraction depends on the wavelength of the starlight and atmospheric density.

A measurement of the refraction of a known star's light near the horizon can be used to infer a direction, in inertial space, from the measurement point, toward the portion of the atmosphere that refracted the light. A star tracker can directly measure this refraction. Alternatively, a difference in refraction, i.e., dispersion, between two different wavelengths, such as red and blue, of starlight can be measured. This concept is referred to as stellar horizon atmospheric dispersion (“SHAD”). However, it should be noted that these two methods are merely different ways of measuring the same basic phenomenon. The relationship between refraction and dispersion is well known for air. Using measured refraction for inferring direction is called stellar horizon atmospheric refraction (“SHAR”). Artificial satellites can also be sighted through the atmospheric limb, thereby combining SkyMark and stellar horizon atmospheric refraction (“SHAR”) and stellar horizon atmospheric dispersion (“SHAD”) techniques.

It is to be understood that extension to SHAR or SHAD techniques of methods and apparatus described herein are within the scope of the present invention.

### 2 Overview

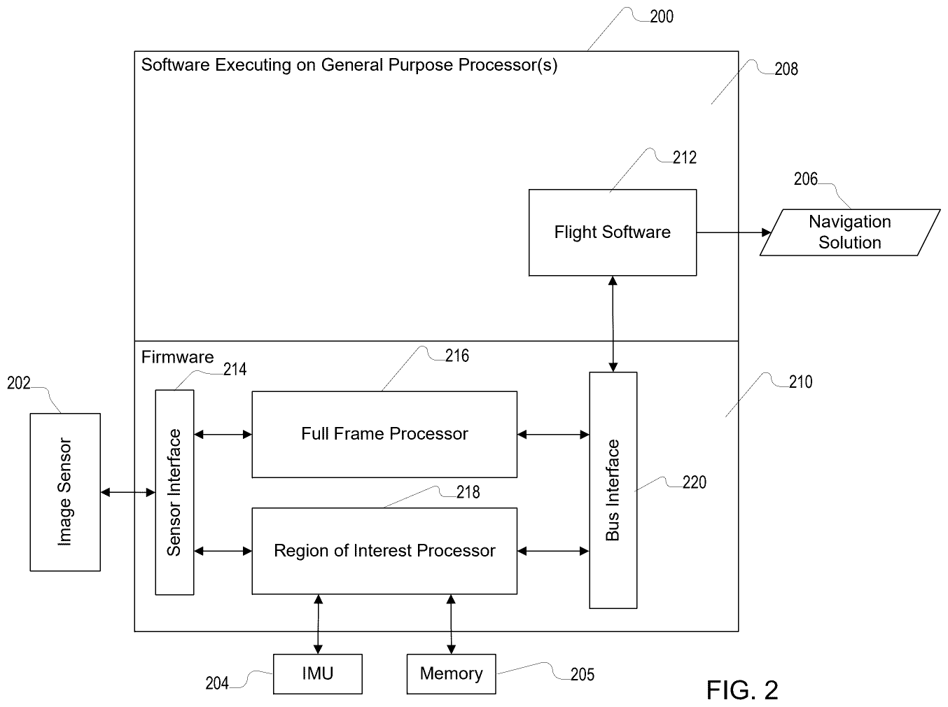

Referring to FIG. 2, a navigation system 200 processes image data from an image sensor 202 and inertial measurement data from an inertial measurement unit (IMU) 204 to track the locations (e.g., coordinates) of celestial bodies over time and to generate a navigation solution 206 based on those locations. The navigation solution 206 is used by a platform (e.g., a vehicle or a missile) for navigation.

In some examples, the navigation system 200 is implemented in two sub-systems: a software sub-system 208 and a firmware sub-system 210. The firmware sub-system 210 reads image data from the image sensor 202 and processes the image data using data from the IMU 204 to generate a set of time-stamped centroids, each representing a location of one or more celestial objects at a time associated with the timestamp. The firmware sub-system 210 provides the time-stamped centroids to the software sub-system 208, which processes the time-stamped centroids using flight software 212 to generate the navigation solution 206. Generation of the navigation solution 206 by the flight software 212 is beyond the scope of this application and is not described further herein. Further details related to generation of the navigation solution 206 by the flight software 212 can be found in the SkyMark references noted above.

### 3 Firmware Sub-System

As is described in greater detail below, the navigation system 200 offloads processing of the potentially large amount of image data from the image sensor 202 to the firmware sub-system 210, where the image data can be processed efficiently and with low latency. In some examples, the firmware sub-system 210 includes a sensor interface 214, a full frame processor 216, a region of interest processor 218, and a bus interface 220.

At a high level, the full-frame processor 216 processes a full-frame image from the image sensor 202 and provides the flight software 212 with candidate objects (associated with resident stellar objects (RSOs) or stars) from that image. Then, the flight software 212 selects a subset of the candidate objects for the region of interest processor 218 to track. The flight software 212 transmits regions of interest (ROIs) for the selected subset of objects to the region of interest processor 218, which tracks the objects in the ROIs over time (including updating the ROI for any objects that leave their original ROI) until some condition is met (e.g., one or more of the RSOs leaves the full frame image and can't be further tracked). It is noted that, in some examples, the flight software uses the objects detected to determine the attitude of the system and then uses that knowledge and an ephemeris catalog to select objects to track (some or all of which may be associated with objects that are not in the candidate objects).

### 3.1 Full Frame Processor

The full-frame processor 216 interacts with the sensor interface 214 to read a “full frame” of image data (i.e., substantially all the pixels from the focal plane array) from the image sensor 202. The full-frame processor 216 processes the image data to perform an initial attitude determination and to identify a candidate set of objects present in the full frame of image data (e.g., 32 objects, ranked by intensity). The candidate set of intensity-ranked objects is sent to the flight software 212 via the bus interface 220.

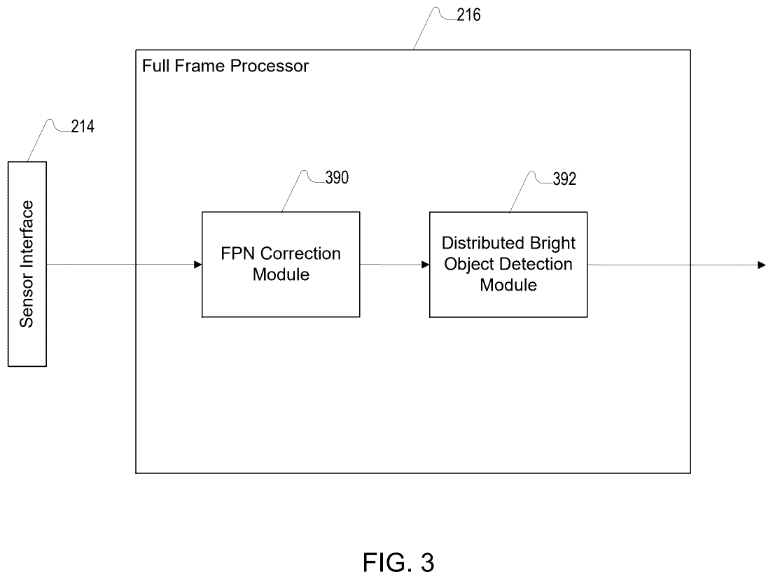

Referring to FIG. 3, in some examples, the full-frame processor 216 includes a fixed pattern noise (FPN) correction module 390 and a distributed bright object detection module 392.

In general, the FPN correction module 390 processes the full frame of image data to reduce spatially consistent noise artifacts that are inherent to the image sensor 202. In some examples, the FPN correction module 390 does so by reading out N electrically generated rows of black pixels from the image sensor 202 (i.e., there is no light information in the rows, so only electronic noise is present) before reading a frame of image data. A noise offset is calculated for each column of the electrically generated image data by comparing an average value of all the electrically generated black pixels to an average value of the electrically generated black pixels in each column of the electrically generated image data, resulting in column-wise noise offsets. The full frame of image data is then processed according to the column-wise noise offsets (e.g., the noise offsets are added to the columns of image data) to correct for the fixed pattern noise.

The FPN corrected image data is then provided to the distributed bright object detection module 392, which processes the image data to identify the candidate set of intensity-ranked objects. In some examples, the candidate set of intensity-ranked objects is top N (e.g., 32) selected as the brightest pixels from distinct detections (e.g., a group of bright pixels associated with a stellar object) in the image data. The candidate set of intensity-ranked objects are output to the bus interface 220.

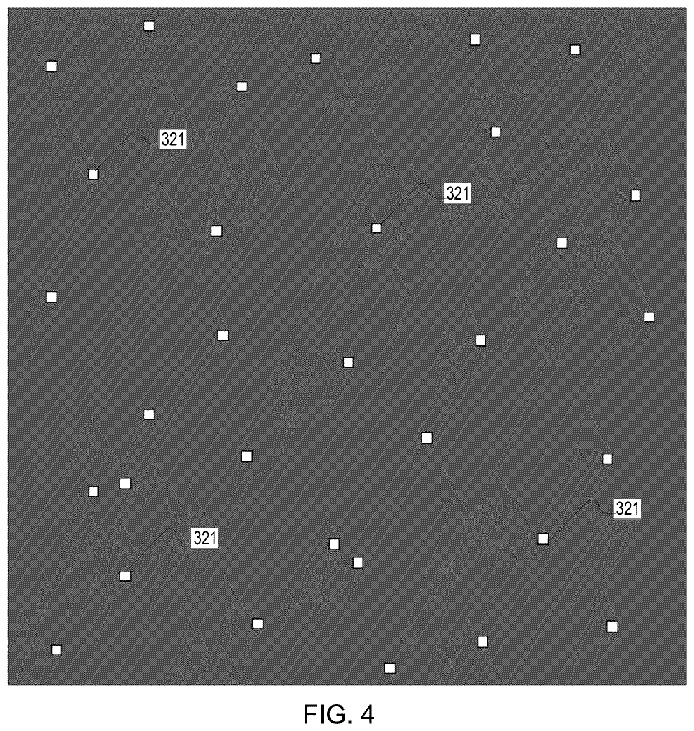

Referring to FIG. 4, one example of a candidate set of objects 321 is shown in the context of a full frame of image data 323. It should be recognized that the full frame of image data is not necessarily sent to the flight software 212 and that the candidate set of intensity-ranked objects may instead be transmitted to the flight software as a list of pixel coordinates in the image frame, ranked by intensity.

The full frame of image data from the image sensor 202 is a large amount of data and reading that large amount of data introduces latency. For example, full frame processing of 5120×5120 pixels can operate at roughly 20 frames per second, which is likely too slow for tracking resident stellar objects in many real-world applications. So, full-frame processing is used for initial attitude determination.

In some examples, the full-frame processor 216 may also process the full-frame image data to remove hot pixels as part of identifying the candidate set of objects.

3.2 Region of Interest Processor

Referring again to FIG. 2, the flight software 212 processes the candidate set of intensity-ranked objects to identify ROIs in the focal plane of the image sensor 202 that are associated with RSOs (e.g., satellites, spacecraft, or stars) that the flight software 212 will use to generate its navigation solution 206. The flight software 212 sends the ROIs to the region of interest processor 218 via the bus interface 220. Very generally, the region of interest processor 218 includes a combination of circuitry and firmware configured to provide faster image frame processing than is available in the full frame processor 216, where a full frame of image data is analyzed. That is, the region of interest processor 218 only reads and processes specific regions of focal plane of the image sensor 202, reducing the amount of data read and processed. Faster frame processing permits the region of interest processor 218 to track fast-moving objects with minimal latency by focusing the image processing on a region of interest within a set of image data that corresponds to a pre-identified celestial object.

The region of interest processor 218 tracks the RSO in each ROI over time to generate the time-stamped centroid for the RSO. Each of the ROIs that flight software 212 sends to the region of interest processor 218 initially has an RSO near its center (i.e., the first image data extracted from the image sensor for the ROI has an RSO near its center). But it is difficult to determine a precise centroid location for the RSO in the ROI from a single image due to the image being noisy. So, the region of interest processor 218 is configured to process and stack a time series image data for the ROI to increase the signal-to-noise ratio, resulting in a precise centroid location for the RSO. Both the RSO and the platform on which the image sensor 202 is mounted may move over time, so the region of interest processor 218 is further configured to compensate for both types of motion before stacking the image data. As part of compensating for motion of the RSO, the region of interest processor 218 can predict when an RSO will leave its ROI and generate a new ROI to continue tracking the RSO (as is described in greater detail below).

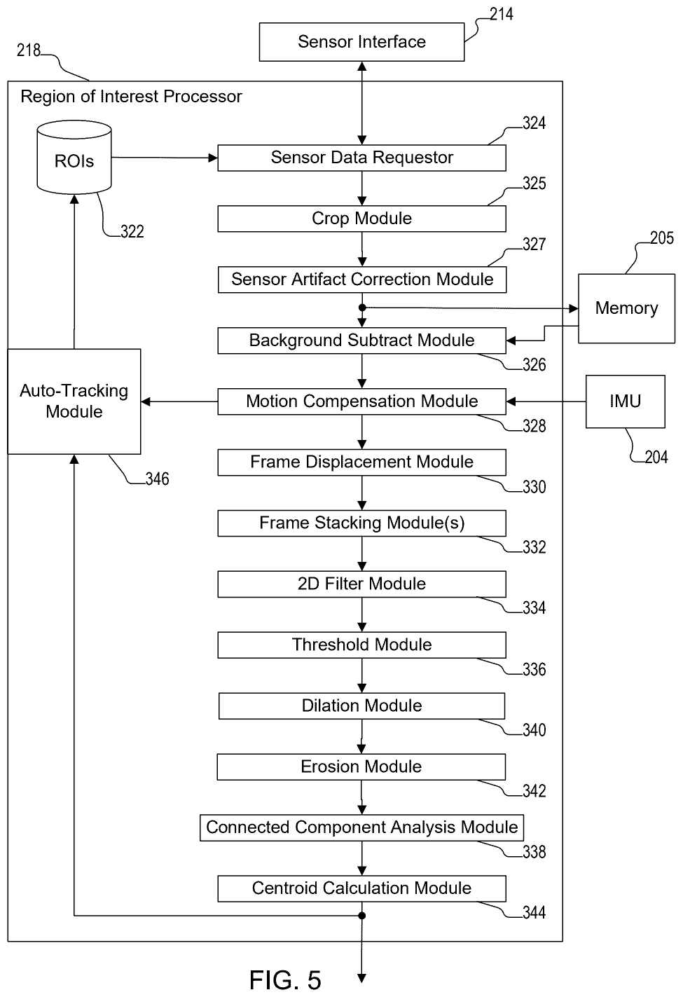

Referring to FIG. 5, in one example, the region of interest processor 218 includes a region of interest data store 322, a sensor data requestor 324, a crop module 325, a sensor artifact correction module 327, a background subtract module 326, a motion compensation module 328, a frame displacement module 330, one or more frame stacking modules 332, a 2D filter module 334, a threshold module 336, a dilation module 340, an erosion module 342, a connected component analysis module 338, a centroid calculation module 344, and an auto-tracking module 346.

The ROI data store 322 stores representations (e.g., pixel coordinates/ranges and optionally timestamps) of the ROIs originally identified by the flight software 212. The sensor data requestor 324 reads the representations of the ROIs from the data store 322 and sends a request for the image data for each ROI to the sensor interface 214. The sensor interface 214 returns image data for each ROI to the sensor data requestor 324, which in turn provides the image data for the ROI to the crop module 325. An efficiency is obtained by reading only parts of the sensor data, and not the entire frame of sensor data.

### 3.2.1 Crop Module

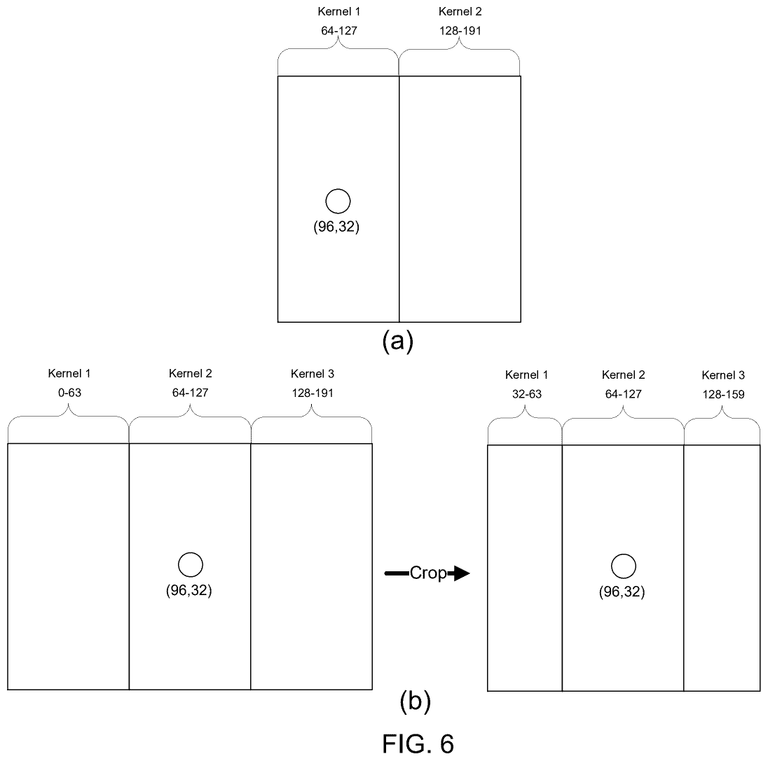

Referring to FIG. 6, in some examples, the ROIs are defined as 128×128 pixel regions and the sensor interface 214 readout is limited to 64 pixel wide “kernels.” As is shown in diagram (a) of FIG. 6, one option is to read two adjacent kernels from the image sensor 202 to form the 128×128 region. However, doing so results in the RSO being off-center in the region of interest. If the RSO moves, this can result in a reduction of time the RSO is present in the ROI. Another option, shown in diagram (b) of FIG. 6, is to read three adjacent kernels and then crop the image data down to form the 128×128 region in the crop module 325. Doing so results in the RSO being centered in the ROI, increasing the amount of time a moving RSO is present in the ROI.

Referring again to FIG. 5, the crop module 325 provides the cropped ROI images as input to the sensor artifact correction module 327.

### 3.2.2 Sensor Artifact Correction Module

In some examples, image sensors (e.g., the Python25K sensor) have column-level nonuniformities, which cause streaks down the image due to incorrect black levels. The sensor artifact correction module 327 processes the cropped ROI images to remove sensor artifacts such as fixed pattern noise, including the incorrect black levels mentioned above. In general, the black level correction module 327 processes the cropped ROI images using the column-wise fixed pattern noise correction algorithm described above for the full frame processor (and not described further here) to linearly transform the pixels in the columns, resulting in black level correction and fixed pattern noise reduction. The corrected ROI images are provided to the background subtract module 326.

The sensor artifact correction module 327 also provides the corrected ROI images to a memory 205, where they are stored in a running buffer (e.g., there is a separate running buffer storing a time series of images for each ROI). It is noted that the external buffer is used to accumulate “background images” to apply during background subtract and other modules in the ROI image processing pipeline can consume the images at a rate that does not require external buffering.

### 3.2.3 Background Subtract Module

For each ROI, the background subtract module 326 processes the input ROI image to remove extraneous background image data such as hot pixels. In some examples, for each ROI, the background subtract module 326 computes a median of the time series of ROI images buffered in the memory 205 and then subtracts that median from the input ROI image. RSOs typically move through ROIs over time, so they are not subtracted out as background, while hot pixels are part of the image sensor and pixels do not move through the ROI over time and are subtracted out as background.

The modified ROI images generated by the background subtract module 326 are provided as input to the motion compensation module 328.

### 3.2.4 Motion Compensation Module

As time progresses, the RSOs move in their respective ROIs due to (1) the motion of the platform on which the image sensor 202 is mounted and (2) the motion of the RSO in space. The motion compensation module 328 processes the modified ROI images to compensate for both types of motion. Ultimately, the motion compensation module 328 generates an x/y shift of the RSOs in their respective ROIs.

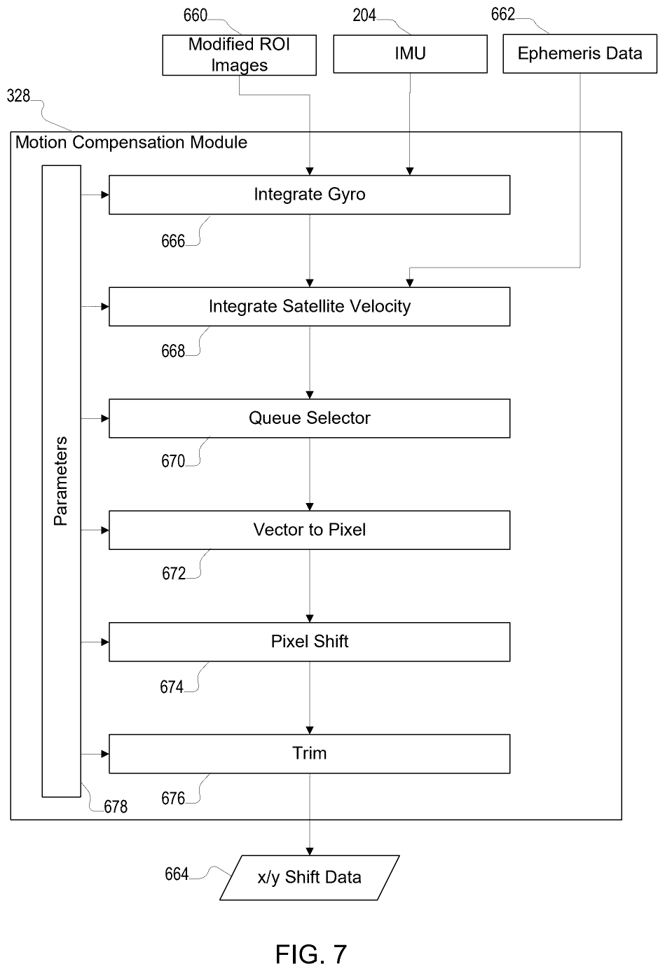

Referring to FIG. 7, in some examples, the motion compensation module 328 receives the modified ROI images 660 from the background subtract module 326 and processes them using inertial movement data from the IMU 204 and ephemeris data 662 from an ephemeris catalog maintained by the flight software 212 to generate x/y shift data 664 that is provided to downstream components in the region of interest processor 218.

The motion compensation module 328 includes an integrate gyro module 666, an integrate satellite velocity module 668, a queue selector module 670, a vector to pixel translation module 672, a pixel shift module 674, and a trimming module 676. Each module modulates or otherwise modifies the modified ROI images and passes the modified data along to the next module.

In general, the x/y shift data 664 generated by the motion compensation module 328 corresponds to the distance (in pixels) between the RSO in the current modified ROI image data (i.e., the current frame) and RSO's location in the initial ROI image data (i.e., the initial frame). The first frame of ROI image data that is read after the flight software 212 provides the ROIs to the region of interest processor 218 (i.e., the first frame of image data read after the stack is reset) is considered the initial reference frame, and all shifts are relative to it. The x/y shift data is 664 generated once per frame. The algorithm runs continuously over the “stack” time; when the flight software causes an ROI switch to track a new RSO or the maximum stack size is reached, the algorithm restarts, clearing all memories and updating its internal parameters 678.

In operation of the motion compensation module 328, the IMU 204 sends packets containing delta theta angles and the flight software 212 provides the velocity of a tracked satellite (from the ephemeris data).

In some examples, the motion compensation module 328 can support multiple active ROIs. In one embodiment, four ROIs can be active at a time. They each track a different RSO (either a satellite, star, or other space object). The motion compensation module 328 produces a unique output for each ROI. In some examples, a time multiplexed scheme saves space by sharing physical resources. However, each ROI is still unique and is controlled and reset separately. The stack for each ROI does not have to be reset at the same time as the other ROIs.

Although there are other supporting blocks, there are four main blocks in motion compensation that contain the algorithm math. These blocks are referred to as “integrate gyro” 666, “integrate satellite velocity” 668, “vector to pixel” 672, and “pixel shift” 674.

The first two blocks, as their names imply, are integrators. Integrate gyro 666 accumulates the delta thetas from the IMU 204 into a rotation matrix, which defines the rotation between the initial and current frames. The integrate satellite velocity block 668 accounts for the motion of the tracked satellite. To calculate the predicted satellite location, both the satellite velocity and the rotation matrix from the integrate gyro block 666 are used. In the case that the RSO of interest is a star, there is no velocity to incorporate, so while the integrate satellite block 668 may still run, the input velocity will be zero. These blocks run each time new delta thetas are received from the IMU 204 and they can produce a unique output for each active ROI every time delta thetas are received.

The second two blocks, “vector to pixel” 672 and “pixel shift” 674 execute when a new frame begins. The vector to pixel block 672 transforms the 3-dimensional unit vector of the RSO into a two-dimensional pixel coordinate (x,y). The pixel shift block 674 applies a bicubic distortion correction to compensate for the physical distortion of the lens associated with the image sensor 202. The motion compensation module 328 then performs the final calculation to determine the difference between the current RSO frame position and the RSO position in the first image. In some examples, the pixel shift block 674 also accounts for tracking an RSO over multiple ROIs.

Because the integration blocks run at the IMU rate and the other two blocks run at the frame rate, there is some synchronization that occurs. The results of the integration blocks are stored in a buffer block, referred to as the queue selection block. The queue selection block 670 contains up-to-date results from the integration blocks. When an image is received and the vector-to-pixel block is ready to begin processing, the queue selection block provides it with the most recent unit position vector.

Motion compensation has multiple applications within the system. First, motion compensation can be used to increase the fidelity of frame stacking. Additionally, it can be used to inform the auto-track module (as is described in greater detail below). Very generally, in auto-tracking, the firmware automatically moves an ROI to keep the RSO in the frame. The motion compensation module 328 informs the auto-tracking module 346 about which way the RSO is moving relative to the frame, and signals when the RSO is nearing the border of the ROI frame.

Referring again to FIG. 5, the modified ROI images and the x/y shift data 664 are provided as input to the frame displacement module 330.

### 3.2.5 Frame Displacement Module

In some examples, the frame displacement module 330 applies an affine transformation to the modified ROI images to generate aligned ROI images. For example, the affine transformation includes applying a translational shift of the modified ROI images according to the x/y shift data 664 such that the RSOs in the aligned ROI images all aligned with the RSO in the initial reference frame for the ROI. In some examples, the translational shift uses an interpolation technique to achieve subpixel accuracy.

The aligned ROI images are provided as input to the frame stacking modules 332.

### 3.2.6 Frame Stacking Modules

The frame stacking modules 332 combine (e.g., by pixel-by-pixel addition) a certain number of aligned images (or frames) for each ROI to generate stacked ROI images that improve the signal-to-noise ratio for detection of the RSO in the ROI. In some examples, the signal-to-noise ratio of a stacked image is defined as:

$$SNR = \sqrt{Num Frames} * ( single image SNR ) .$$

The frame stacking modules 332 can operate in different modes such as continuous stacking output and full stack-only output. In continuous stacking mode, the stacked image is output as additional frames are stacked, while in full-stack mode, the stacked image is only output after all frames have been stacked (e.g., a set number of frames have been stacked or the software commands a switch in ROIs).

The stacked ROI images are provided as input to the 2D filter module 334.

### 3.2.7 2D Filter Module

The 2D filter module 334 applies a filter kernel, w to the each of the stacked ROI images (represented as ƒ(x, y)) to generate a corresponding filtered ROI image, g(x, y) as follows:

$$g ( x , y ) = ω * f ( x , y ) = {\sum }_{dx = - a}^{a} {\sum }_{dy = - b}^{b} ω ( dx , dy ) f ( x - dx , y - dy )$$

Different types of 2D filtering can be performed based on the filter kernel. For example, high pass filtering or unsharp mask filtering may be applied. In general, the filtering is low-latency because the filter is applied as the image arrives and without having to be stored in memory. Furthermore, the 2D filter can operate in a pixel-by-pixel mode and can be serialized or parallelized.

The filtered ROI images generated by the 2D filter module 336 are provided as input to the threshold module 336.

### 3.2.8 Threshold Module

The threshold module 336 processes the filtered ROI images to select which pixels in the images should be considered as detections for later centroid identification. In some examples, the threshold module 336 first builds a histogram with 4000 bins, into which the pixels of the filtered ROI images are grouped based on intensity. Then, one of three threshold modes is applied to the histogram: manual mode, interquartile range (IQR) mode, 50% point mode, and 97.5% point mode.

In manual mode, the flight software selects a threshold to apply to the histogram. In IQR mode, a statistical method is used to determine a threshold to apply to the histogram. The statistical method involves calculating the first quartile (Q1) and third quartile (Q3) of intensity values, determining the IQR as the difference between Q3 and Q1, and defining a range using a threshold multiplier. Pixels with intensity values falling above the range are considered to be detections for later centroid calculation. 50% point mode and 97.5% point mode simply classify all pixels with intensity values above the 50% or 97.5% intensity values as detections. In some examples, IQR thresholding mode is preferred.

Any pixels in the filtered ROI images that are below the thresholds are zeroed out to create thresholded ROI images. The thresholded ROI images are provided to the dilation and erosion modules 340, 342.

### 3.2.9 Dilation and Erosion Module

Continuing to refer to FIG. 5, in some examples, the dilation and erosion modules 340, 342 apply masks (e.g., 5×5 masks) to add additional pixels or subtract pixels to or from the thresholded ROI images (e.g., to fill holes in groups of similar pixels or remove extraneous parts from the groups). The eroded and dilated ROI images are provided to the connected component analysis module 338.

### 3.2.10 Connected Component Analysis Module

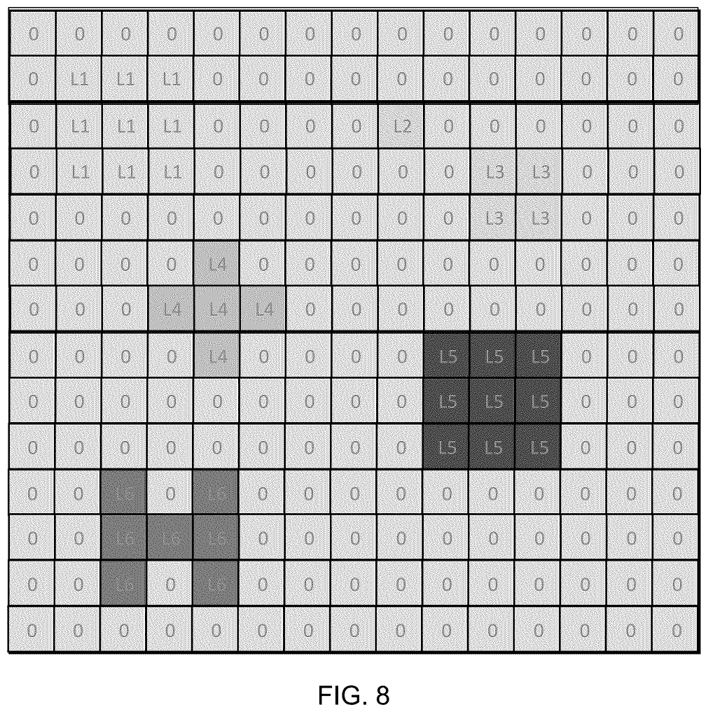

The connected component analysis module 338 groups connected pixels in the dilated and eroded ROI images and assigns the groups unique labels. For example, referring to FIG. 8, six unique groups of pixels in a thresholded ROI image are identified using conventional connected component analysis techniques: L1, L2, L3, L4, L5, and L6. The ROI images with unique groups of pixels identified are provided to the centroid calculation module 344.

### 3.2.11 Centroid Calculation Module

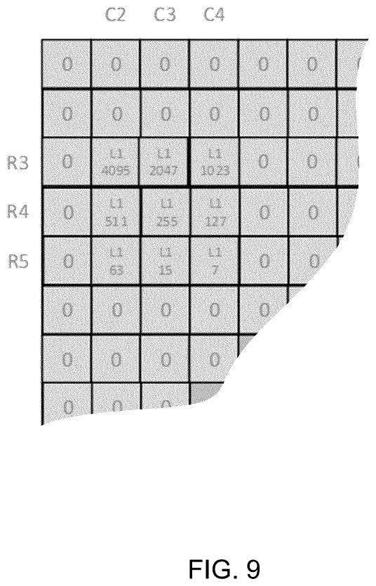

The centroid calculation module 344 processes the ROI images to determine a centroid for each of the groups identified by the connected component analysis module 344. For example, referring to FIG. 9, a center of mass calculation is performed to determine x and y coordinates for the centroid associated with the first group (L1) using the following equations:

$$Xcm = {\sum }_{i = 1}^{N} \frac{{m}_{i} {x}_{i}}{M}$$

$$Ycm = {\sum }_{i = 1}^{N} \frac{{m}_{i} {y}_{i}}{M}$$

For example, the calculation yields the center of mass of the centroid for the first group (L1) at the x/y pixel location (2.5, 3.13):

$$Xcm = \frac{\begin{matrix}( 4095 * 2 ) + ( 2047 * 3 ) + ( 1023 * 4 ) + ( 511 * 2 ) + \\ ( 255 * 3 ) + ( 127 * 4 ) + ( 62 * 2 ) + ( 15 * 3 ) + ( 7 * 4 )\end{matrix}}{4095 + 2047 + 1023 + 511 + 255 + 127 + 63 + 15 + 7} = 2.5$$

$$ycm = \frac{\begin{matrix}( 4095 * 3 ) + ( 2047 * 3 ) + ( 1023 * 3 ) + ( 511 * 4 ) + \\ ( 255 * 4 ) + ( 127 * 4 ) + ( 63 * 5 ) + ( 15 * 5 ) + ( 7 * 5 )\end{matrix}}{4095 + 2047 + 1023 + 511 + 255 + 127 + 63 + 15 + 7} = 3.13$$

The centroid locations for the RSOs in the ROIs are time stamped (e.g., with a time associated with the initial frame for the ROI) and sent out of the region of interest processor 218 to the flight software 212.

### 3.2.12 Auto Track Module

Referring again to FIG. 5, the centroid locations for the RSOs in the ROIs are also provided to the auto-tracking module 346 along with the x,y shift data from the motion compensation module 328. In general, the auto-tracking module 328 monitors the locations of the RSOs in their respective ROIs and, when an RSO is about to move out of its ROI, updates the ROI for the RSO to continuously track the location of the RSO. Performing auto-tracking in firmware allows for tracking of fast-moving objects that software-based auto-tracking would likely take too long to track.

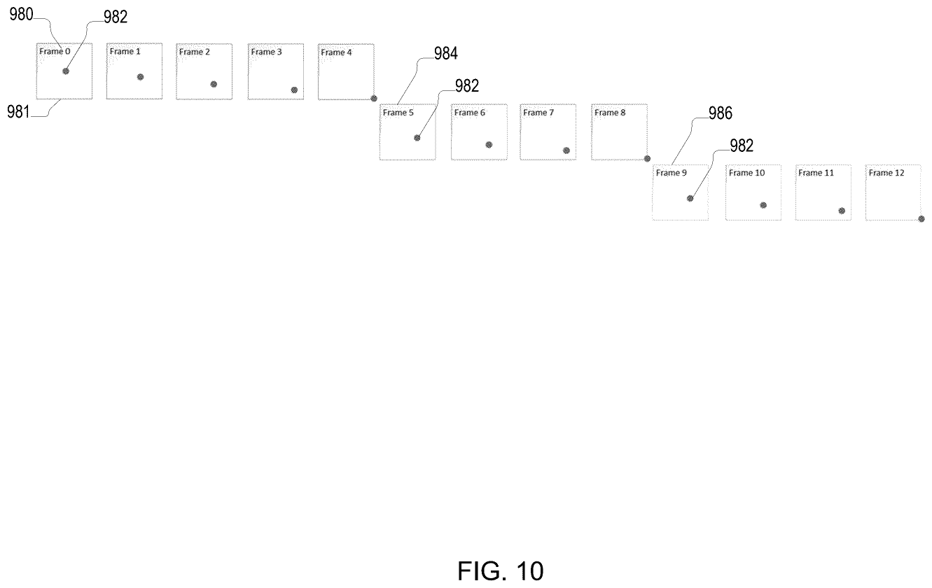

Referring to FIG. 10, after the flight software 212 provides the ROIs for tracking to the region of interest processor 218, the region of interest processor 218 begins reading the regions of interest from the image sensor 202. In the initial frame (frame 0) 980, the RSO 982 is near the center of the ROI 981. Over frames 1-4, the RSO 982 moves to the lower right corner of the ROI. The auto-tracking module 346 identifies that the RSO is about to leave the ROI and determines a new ROI 984 for the RSO 982. The new ROI 984 is provided to the region of interest data store 322, where it replaces the original ROI for the RSO.

The region of interest processor 218 then reads image data for the new region of interest over frames 5-8. At that point, the auto-tracking module 346 again identifies that the RSO is about to leave the new ROI 984 and determines yet another new ROI 986 for the RSO 982. The new ROI 986 is provided to the region of interest data store 322, where it replaces the previous ROI for the RSO, and the process continues until the flight software assigns new ROIs, or the RSO leaves the full frame of the image sensor 202.

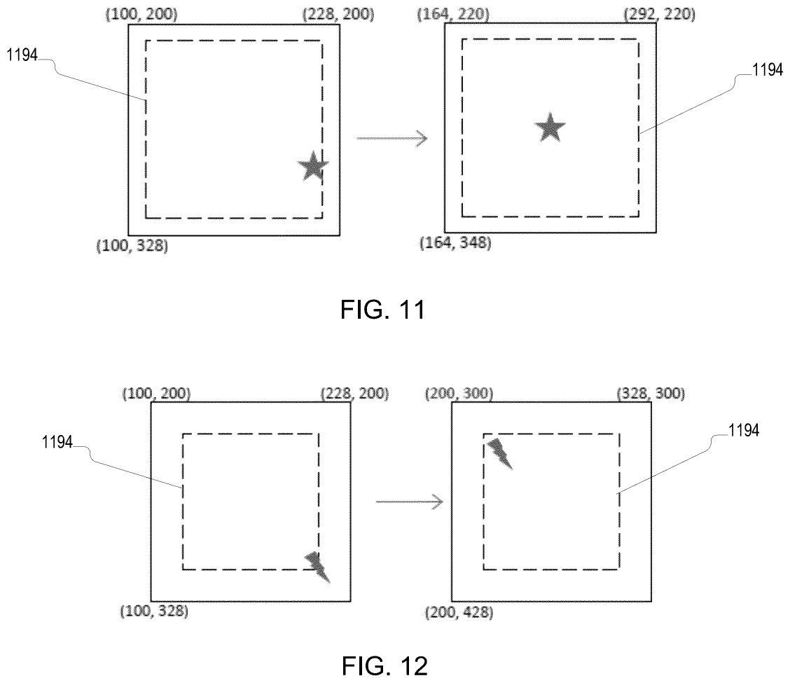

Referring to FIGS. 11 and 12, in some examples, the auto-tracking module 346 has a configurable auto-track boundary 1194 that is used to determine when the RSO is about to leave its ROI. For example, in FIG. 11, the RSO is a star, so the auto-track boundary 1194 is configured to be narrow because stars are not expected to move. When the star crosses the auto-track boundary 1194, the star is placed in the center of a new ROI.

Referring to FIG. 12, the RSO is a satellite, so the auto-track boundary 1194 is configured to be wider than it is for a star, due to the expected movement of the satellite. When the satellite crosses the auto-track boundary 1194, the satellite is placed in the opposite corner of its motion (e.g., as determined by a location where the satellite crossed the auto-track boundary 1194) in a new ROI to increase the amount of time that the satellite is in the new ROI.

It is noted that, when the auto-tracking module 346 updates the ROI location in the region of interest processor 218, it also provides the necessary information to the motion compensation and stacking modules to ensure the new ROI location is considered in shift calculations.

In some examples, the auto-tracking module 346 uses a tracking filter (e.g., a Kalman filter) to track the RSO. In other examples, the auto-tracking module 346 uses a closed-loop controller such as a PID controller to track the RSO.

In some aspects, the auto-tracking module 346 is implemented in software. However, it is preferable to have the auto-tracking module 346 implemented in firmware, as shown in FIG. 5 to ensure low latency operation.

In some aspects (not shown), the auto-tracking module 346 provides a “track lock” signal to the flight software to indicate that an RSO has been successfully identified in the image. The flight software can use the “track lock” signal to inform when to command a switch to track a new RSO.

### 4 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for localization of a platform, the method comprising:
receiving, at a region of interest processor, region of interest data representing less than an entire focal plane array of an image sensor and comprising a plurality of regions of the focal plane array of the image sensor, where the plurality of regions includes a first region containing a first stellar object;
for each time of a plurality of successive times, processing the region of interest data, including:
extracting image data from the focal plane array of the image sensor for the plurality of regions,
processing the image data for the first region to update a track of movement of the first stellar object through said first region;
for at least a first time of the plurality of successive times, determining that the first stellar object will move out of the first region and updating a location in the imaging sensor of the first region at the first time according to the track of the first stellar object, for use in processing the region of interest data at subsequent times.

2. The method of claim 1 further comprising extracting full-frame image data from the entire focal plane array of the image sensor, processing the full-frame image data to identify a plurality of candidate stellar objects in the full-frame image data, and providing the plurality of candidate stellar objects to flight software.

3. The method of claim 2 further comprising processing the plurality of candidate stellar objects in the flight software to determine the region of interest data.

4. The method of claim 3 wherein processing the full-frame image data is performed in firmware.

5. The method of claim 1 wherein processing the image data for the first region to update the track of movement of the first stellar object, determining that the stellar object will move out of the first region, and updating the location in the imaging sensor of the first region at the first time is performed in firmware.

6. The method of claim 1 wherein processing the image data for the first region to update the track of movement of the first stellar object, determining that the stellar object will move out of the first region, and updating the location in the imaging sensor of the first region at the first time is performed in software.

7. The method of claim 1 wherein updating the track of movement for the first stellar object includes compensating for a movement of one or both of the platform and the first stellar object.

8. The method of claim 7 wherein updating the track of movement for the first stellar object further includes using a tracking filter.

9. The method of claim 1 further comprising, for each region of the region of interest data, processing a plurality of successive images extracted at the plurality of successive times to identify a centroid of the stellar object in the region.

10. The method of claim 9 wherein identifying the centroid of the stellar object in the region includes determining a background image for the region and subtracting the background image from the plurality of successive images.

11. The method of claim 10 wherein identifying the centroid of the stellar object in the region further includes compensating for a motion of one or both of the stellar object in the region and the platform in the plurality of successive images to generate a plurality of motion-compensated successive images.

12. The method of claim 11 wherein identifying the centroid of the stellar object in the region further includes stacking the plurality of motion-compensated successive images to generate a stacked image.

13. The method of claim 12 wherein identifying the centroid of the stellar object in the region further includes applying a two-dimensional filter to the stacked image to generate a filtered image.

14. The method of claim 13 wherein identifying the centroid of the stellar object in the region further includes applying a threshold to the filtered image to generate a thresholded image.

15. The method of claim 14 wherein identifying the centroid of the stellar object in the region further includes identifying pixels associated with the stellar object in the region using a connected component analysis.

16. The method of claim 15 wherein identifying the centroid of the stellar object in the region further includes performing erosion and/or dilation on the identified pixels.

17. The method of claim 16 wherein identifying the centroid of the stellar object in the region further includes calculating a center of mass of the identified pixels.

18. A system for localization of a platform, the system comprising:
an input for receiving, at a region of interest processor, region of interest data representing less than an entire focal plane array of an image sensor and comprising a plurality of regions of the focal plane array of the image sensor, where the plurality of regions includes a first region containing a first stellar object;
one or more processing modules configured to, for each time of a plurality of successive times, process the region of interest data, the processing including:
extracting image data from the focal plane array of the image sensor for the plurality of regions,
processing the image data for the first region to update a track of movement of the first stellar object through said first region;
for at least a first time of the plurality of successive times, determining that the first stellar object will move out of the first region and updating a location in the imaging sensor of the first region at the first time according to the track of the first stellar object, for use in processing the region of interest data at subsequent times.

19. Data stored on a non-transitory medium comprising configuration instructions for configuring a circuit having:
an input for receiving, at a region of interest processor, region of interest data representing less than an entire focal plane array of an image sensor and comprising a plurality of regions of the focal plane array of the image sensor, where the plurality of regions includes a first region containing a first stellar object;
one or more processing modules configured to, for each time of a plurality of successive times, process the region of interest data, the processing including:
extracting image data from the focal plane array of the image sensor for the plurality of regions,
processing the image data for the first region to update a track of movement of the first stellar object through said first region;
for at least a first time of the plurality of successive times, determining that the first stellar object will move out of the first region and updating a location in the imaging sensor of the first region at the first time according to the track of the first stellar object, for use in processing the region of interest data at subsequent times.

20. The data stored on a non-transitory medium of claim 19 wherein the instructions are configured to configure a field programmable gate array (FPGA).
